(19) United States
(12) Patent Application Publication
(10) Pub. No.: US 2014/0130465 A1
(43) Pub. Date: May 15, 2014

(54) SAFETY DEVICE FOR SADDLES

(71) Applicant: Rodrigo Rodriguez Ojeda, Llanes (Asturias) (ES)

(72) Inventor: Rodrigo Rodriguez Ojeda, Llanes (Asturias) (ES)

(21) Appl. No.: 14/129,686

(22) PCT Filed: Jun. 29, 2011
(86) PCT No.: PCT/ES2011/070474

§ 371 Date: Dec. 27, 2013

(51) Int. Cl. B68C 1/18

(52) U.S. Cl. CPC B68C 1/18
USPC 54/44.1

(57) ABSTRACT

The present invention relates to a safety device for saddles comprising:

A) a harness comprising a belt (4) which can be fastened around the waist of a rider (1) mounted on a horse (2), where said belt (4) is secured by means of securing elements (5) to bars (10) which are anchored to a securing base (8) located on the horse (2),

B) a quick closure (9) to which the belt (4) is anchored, and

C) a sensor (16) sensing the position of the horse (2) which can act on the quick closure (9).

### TECHNICAL FIELD OF THE INVENTION

The present invention relates to a safety device for saddles which is applied in the field of horseback riding, and more specifically for training and for practicing high-risk riding, allowing the rider to stay balanced on the saddle, preventing the rider from losing his/her balance and from falling in any direction.

### BACKGROUND OF THE INVENTION

There are various devices today intended for assuring the safety of a horseback rider in order to keep said rider on the saddle.

French patent application no. FR-2552065-A1 describes a belt fixed to the saddle and to the waist of the rider assuring that he/she is balanced against the risk of falling, but which belt however prevents the rider from moving up and down when trotting, greatly limiting his/her movements and training in a rigid manner.

On the other hand, European patent application no. EP-0860397-A1 describes a safety belt for a rider which has only two anchors, one front anchor and another rear anchor, for anchoring to the saddle. The main drawback of this device is due to the fact that the securing bands have to be long enough so as to allow the rider to move up and down when trotting, so that they in turn do not prevent said rider from being able to fall to one side or another, being suspended from said two bands. In the event of a fall to the side, the rider has enormous difficulty in incorporating himself/herself on the saddle again, experiencing serious danger both if the fall occurs at the time of jumping over a hurdle and if the horse bolts, in addition to the fact that in said situation the rider cannot release himself/herself from the securing harness such that he/she inevitably falls together with the horse, with the subsequent risk of being crushed by the animal.

European patent application no. EP-0974549-A1 contemplates two rear anchors which anchor the rider to the saddle such that the rider is protected from falling to the side and from falling forward but it does not assure isostasy on the saddle when jumping over hurdles or when the horse takes off suddenly at a gallop, for example, such that it does not prevent the rider from falling backwards. Said system further introduces added risk factors as the rider is kept in suspension for an indefinite time on the hindquarters of the horse without allowing him/her to recover his/her position on the saddle.

Said application also contemplates the use of two side reels for the securing bands for securing the rider to the saddle, which allow the deployment thereof when the rider raises himself/herself above the saddle as the horse trots and which are retracted when the rider lowers himself/herself until sitting on the saddle. However, taking into account that said movements occur extremely quickly while riding, the actual effect of the reels is that they delay or slow down the movement of the rider, given that it is the rider himself/herself who has to deploy them with his/her body during upward movement, a short delay of a fraction of a second being sufficient for its accumulated effect while horseback riding to cause the rider's movement to be out of rhythm with that of the mount, so this technical solution entails negative effects for riding and prevents a new rider from training correctly.

Finally, the existence of a horseback riding safety system described in international application no. WO-2009/125026-A1 is also known, which system describes, among others, an abdominal belt intended for being placed on the waist of the rider, where said belt is anchored to the saddle itself by means of tensioning elements. In this case, the means for securing the rider have to be incorporated to the saddle itself during manufacture or incorporated “a posteriori”, which may be complex, and they will be part of the saddle in any case, whether or not the rider requires them.

### DESCRIPTION OF THE INVENTION

The present invention relates to a safety device for saddles which allows overcoming the drawbacks and limitations of the state of the art by means of the device defined by claim 1.

The device of the invention allows training for horseback riding, as well as practicing high-risk riding, allowing the rider to stay on the saddle in isostasy and preventing the rider from losing balance and falling in any direction.

Likewise, the device comprises a safety closure or lock which can be instantly opened automatically and manually to allow the rider to be released from the harness in the event that the horse falls either because it slips on the ground or trips when jumping over a hurdle, thus preventing the rider from being crushed.

The proposed invention consists of a safety device for saddles comprising:

A) A harness attaching the rider to the horse and comprising:
a securing base which is located between the saddle and the horse, preferably between the saddle and the protective horse blanket, such that the securing base is attached to the horse by the saddle itself. The securing base has a shape which adapts to the horse and combines stiff parts with other flexible parts for better adaptation and at the same time for the best support and distribution of the stresses exerted by the rider thereon when he/she loses his/her balance. The securing base can be manufactured from Kevlar, carbon fiber or other composites.
a belt which is arranged around the waist of the rider and the ends of which are coupled to a closure or clasp.
securing elements between the belt and the securing base. These securing elements are three in number, one front securing element and two rear securing elements, whereby isostasy is achieved, preventing the rider from being able to fall off the horse in any direction. The front securing element is a simple band attached at one end to the securing base and at the other end to the closure or clasp. The rear securing elements consist of a pair of bars located one on each side of the securing base and attached thereto by means of an articulation or a hinge which is anchored to the securing base itself. The belt is attached to these bars by means of stirrups or straps. The articulation of the bars allows the rider to move up and down when trotting, in addition to allowing him/her a suspension position for galloping or jumping.

The forward travel of the securing bars is limited by means of a stop in order to prevent excessive movement of the rider in that direction.

The free end of the bars is bent to form a loop preventing possible injuries in the rider if he/she contacts same. Furthermore, the bars have a curved shape that opens outwardly.

In a more economical embodiment variant, the securing base can be made of leather and the securing elements, i.e., the securing belt and securing bands for securing same to the securing base, can also be made of leather or a suitable material.

B) A closure or clasp to which the ends of the belt are attached. The closure or clasp is attached to the securing base by means of a band or strap. The clasp has electromechanical means, such as an electromagnet or a motor, controlled by a fall sensor which allows releasing the ends of the belt manually (by pressing a release button of the closure itself) or automatically, in the first case when the rider wants to do so and in the second case in response to a possible fall off the horse generating a signal from the fall sensor.

C) A sensor which is preferably located in a front part or journal of the securing base and which is electrically connected to the quick closure for release, incorporating a battery for powering same, which can be located in a housing envisaged for that purpose in the securing base itself. Said sensor will be described in greater detail below.

The invention solves the main problems in training for horseback riding and high-difficulty riding with horses that have a nervous temperament, offering the rider means that can be adapted to any class of saddles.

The system has several objectives:

The first objective is to prevent the rider from falling off the horse as he/she loses his/her balance for any reason. This is very practical, for example, in teaching horseback riding.

In the event that the horse loses its balance and falls, there are means which allow automatically releasing the rider from the securing harness. Those means consist of a fall sensor which sends a signal to the quick closure or clasp to which the ends of the belt are attached so that it opens and the rider is freed from the belt. An electric cell fixed at any point of the securing base of the harness can power the sensor and the electromagnet of the clasp which are interconnected.

The means of the device are such that they allow the rider the necessary mobility for practicing horseback riding, both at the teaching level and at the competitive level. For this reason the bars are articulated to the securing base and the attachment thereof to the belt is by means of stirrups. Also for this reason the clasp is attached to the securing base in the front attachment by means of a band.

### DESCRIPTION OF THE DRAWINGS

To complement the description that is being made and for the purpose of aiding to better understand the features of the invention according to a preferred practical embodiment thereof, a set of drawings is attached as an integral part of said description in which the following has been depicted with an illustrative and non-limiting character:

FIG. 1 shows a schematic rear perspective view of an embodiment of the device of the invention located in its working position on a horse and placed on a rider, where the rider and the bars in their lowest position while horseback riding can be seen.

FIG. 2 shows a view such as that of FIG. 1 in which the rider and the bars are in their highest position while horseback riding, the securing elements linking the bars with the belt which the rider puts on being seen. An inner stop of the hinge limits the maximum forward travel of the bars, i.e., towards the head of the horse.

FIG. 3 shows a view such as that of FIGS. 1 and 2 but viewed from a side, in which the rider and the bars are in an intermediate position between the positions depicted in FIGS. 1 and 2.

FIG. 4 shows a schematic side perspective view of an embodiment of the device of the invention placed on the horse blanket, not depicting the saddle which would be placed on the device such that the securing base of the device would be located between the horse blanket and the saddle.

FIG. 5 shows a side perspective view of an initial moment when a rider puts the belt on.

FIG. 6 shows a front perspective view of the location of the closure or clasp at the time of coupling the ends of the lumbar belt to same.

FIG. 7 shows a side perspective view of a variant of the securing base of the device placed on the horse blanket.

FIG. 8 shows a perspective view such as that of FIG. 5 of the variant of the device depicted in FIG. 7.

FIG. 9 shows a view which is a continuation of that of FIG. 8 in a moment when the rider fastens the ends of the belt to the clasp.

FIG. 10 shows a view of the embodiment variants of FIGS. 8 and 9 in which a possible complementary securing for securing the safety device to the saddle and, more specifically, a possible complementary securing for securing the securing base of the harness to the saddle, are shown.

FIG. 11 shows the securing base manufactured from a resistant, lightweight material such as fiber glass or Kevlar, without the protective and in turn decorative cover, the location of the hinges or anchors of the bars and the position of the sensor coupled in the front part of the securing base being seen therein.

FIGS. 12 to 17 show the views and cross-sections of the closure or clasp and their components.

### PREFERRED EMBODIMENT OF THE INVENTION

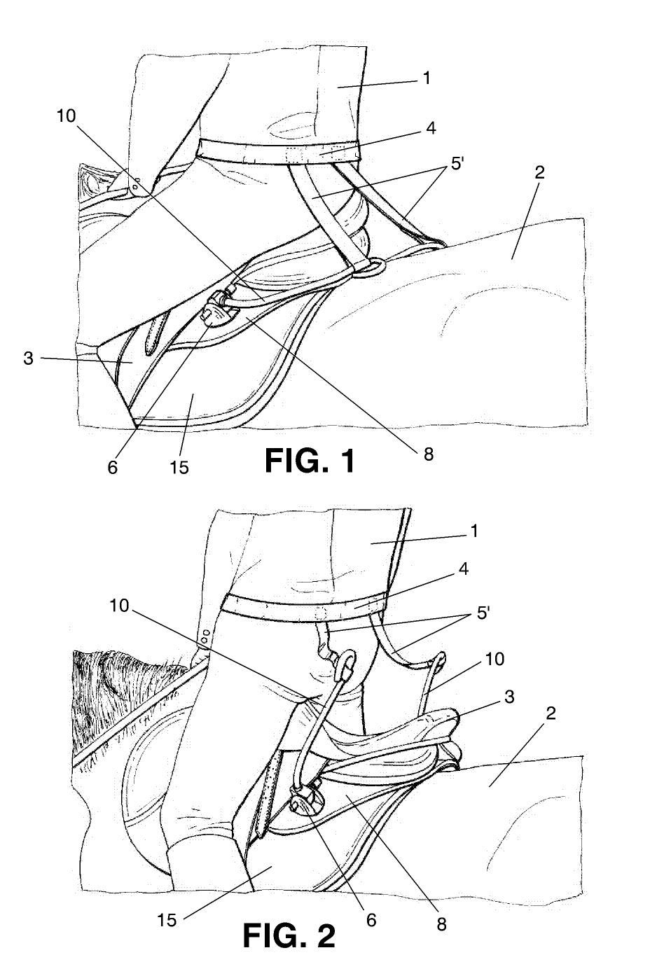

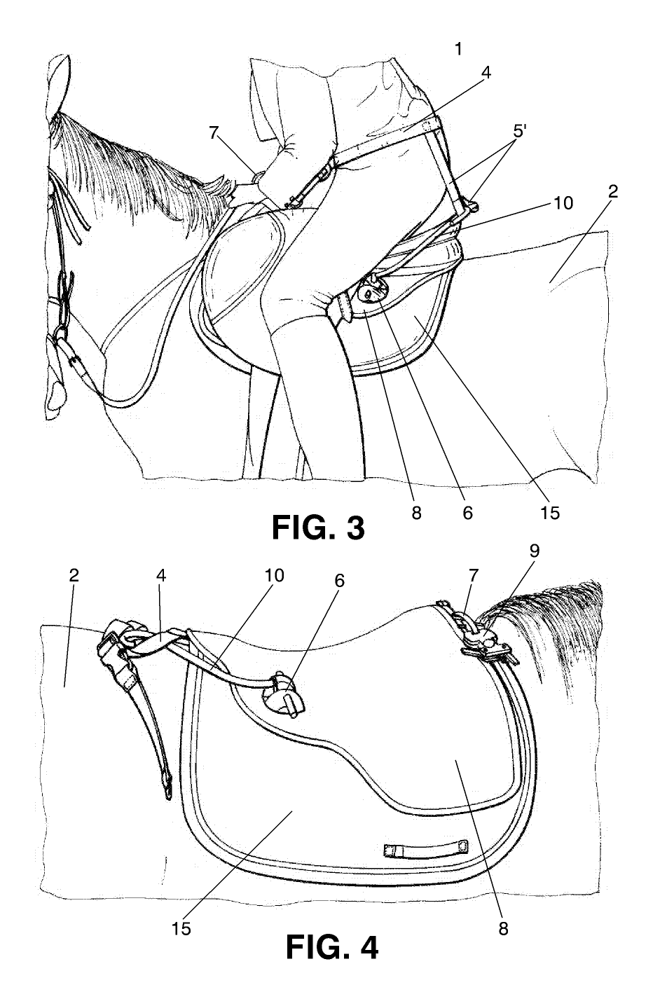

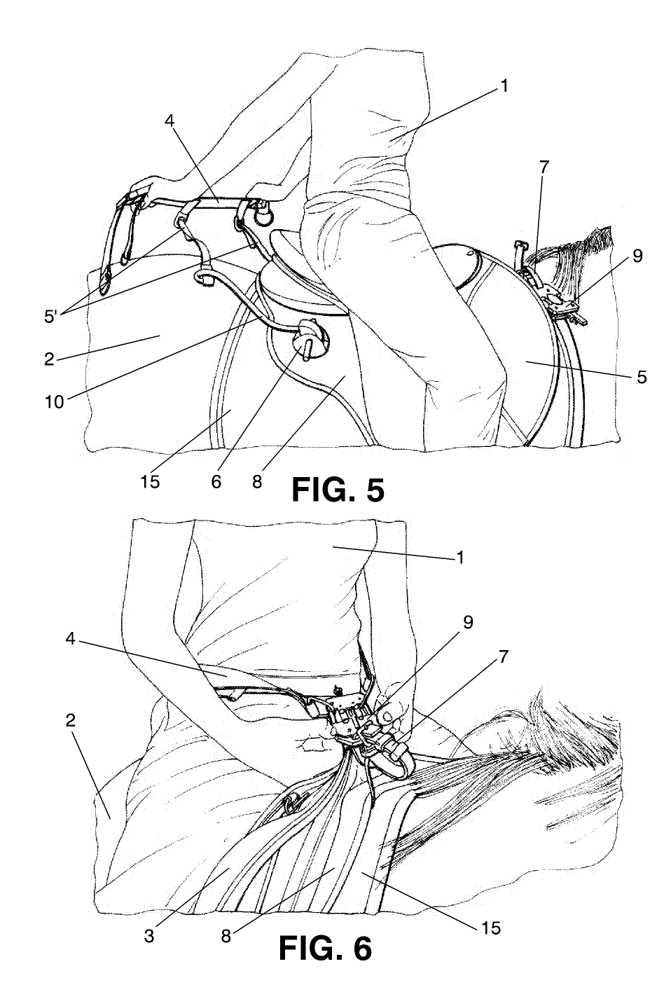

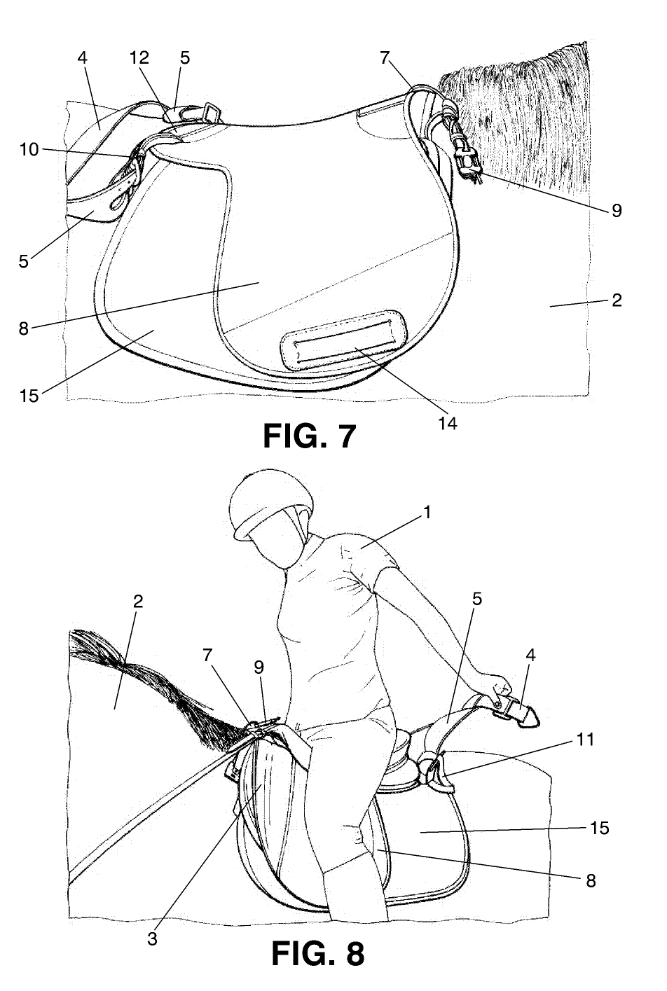

FIGS. 1 to 6 show the preferred embodiment of the invention comprising a harness formed by:
a securing base (8) which is located between the saddle (3) and the horse (2). The securing base (8) as being located between the saddle and the protective blanket (15) is observed in the drawings. The securing base (8) has the necessary shape and flexibility for being adapted to the horse and the necessary stiffness and strength for withstanding the stresses exerted by the rider thereon when he/she loses his/her balance. It can be manufactured from Kevlar, carbon fiber or other composites which suitably allow combining stiff areas with flexible areas. In FIGS. 1 to 6, the securing base (8) is covered with a saddle blanket or cloth so as to not damage the saddle by abrasion.
Anchoring parts or hinges (6) are firmly attached to the securing base (8), one on each side.
a belt (4) going around the waist of the rider in an operative position. The ends of the belt are coupled to the clasp (9) which is in turn attached to the front part of the securing base by means of a band (⁷),
securing means consisting of two rear bars (10) attached in an articulated manner to a hinge or anchor (6), located one on each side of the securing bases (8). The forward movement of the bars is limited by means of a stop to prevent the excessive lowering of the rider towards the head of the horse. The movement of the bars in the opposite direction, i.e., towards the tail of the horse, is not limited.
The hinge (6) is rigidly attached to the securing base (8).
The end of the bars (10) is curved forming a loop which prevents the rider from being harmed if he/she contacts the bars.
The belt (4) is attached to the bars (10) by means of stirrups or straps (5′). Obviously, it would be possible to attach the belt (4) directly to the bars (10), but it would be more uncomfortable for riding.

The rider is thus attached to the securing base at three points, one front point and two rear points, achieving isostasy.

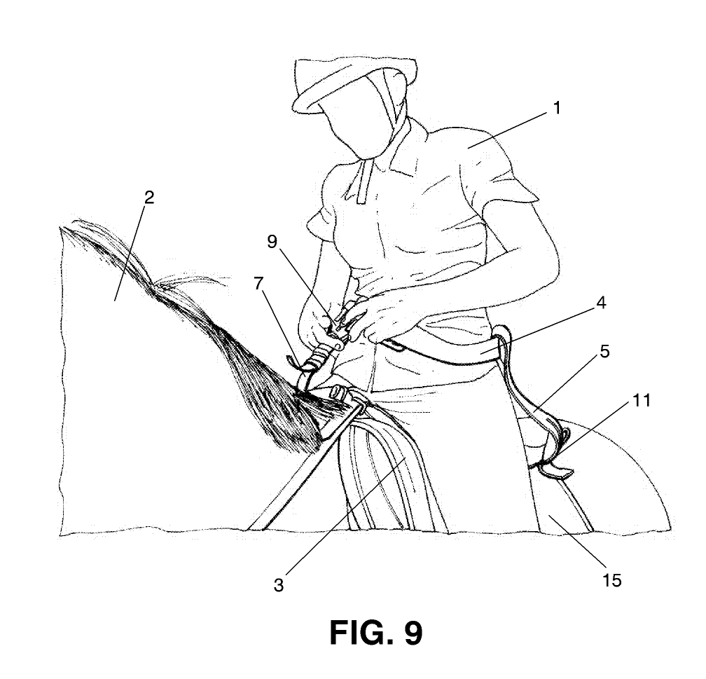

The harness can be made in a more economical manner by manufacturing the securing base from leather or felt and with the securing elements also manufactured from leather, but the efficacy thereof is somewhat lower. This embodiment is illustrated in FIGS. 8 to 11. These figures show a securing base (8) made of leather to which a clasp (9) is frontally attached by means of a leather band (7). The back securing elements are two bands (5) which are attached to the belt (4) at one end and to the base (8) at the other end by suitable means. In this manner, once the belt (4) is closed through the clasp (9), the rider is secured to the horse by three securing points.

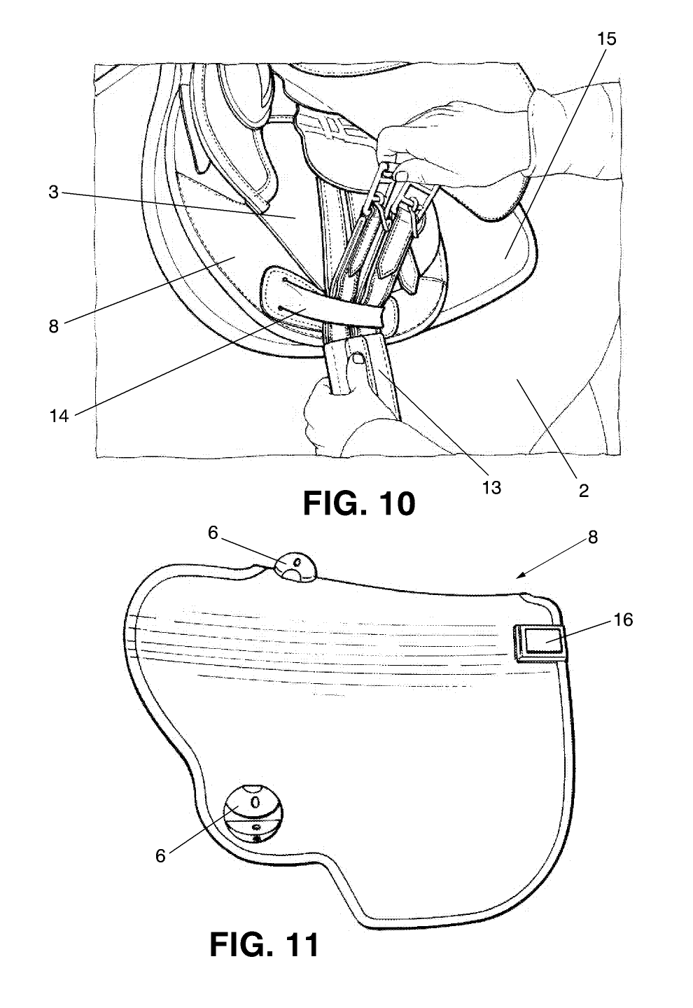

FIG. 10 depicts a detail in which the securing base (8) comprising at least one securing strap (14) which allows the passage of a cinch (13) of a saddle (3) for securing same to a horse (2) is seen.

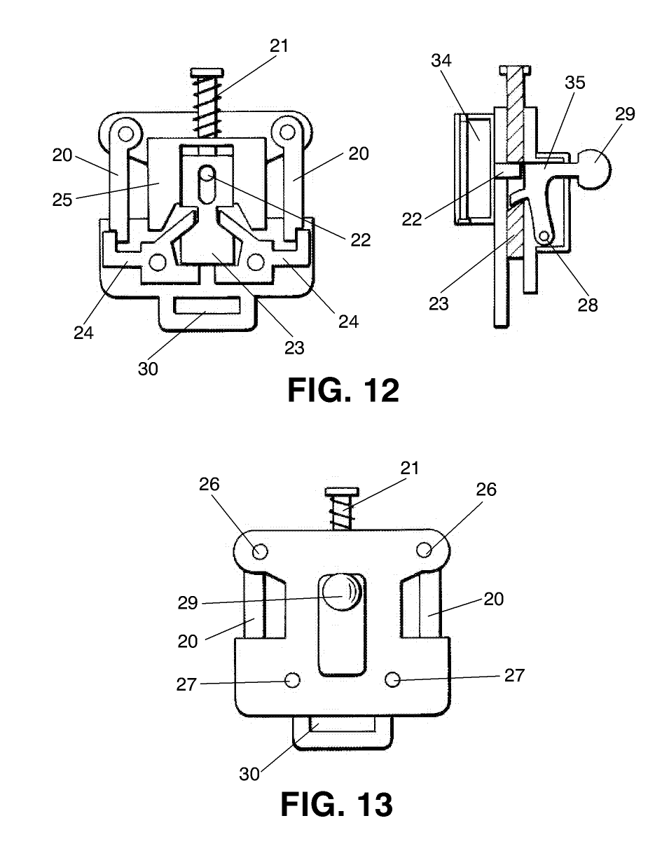

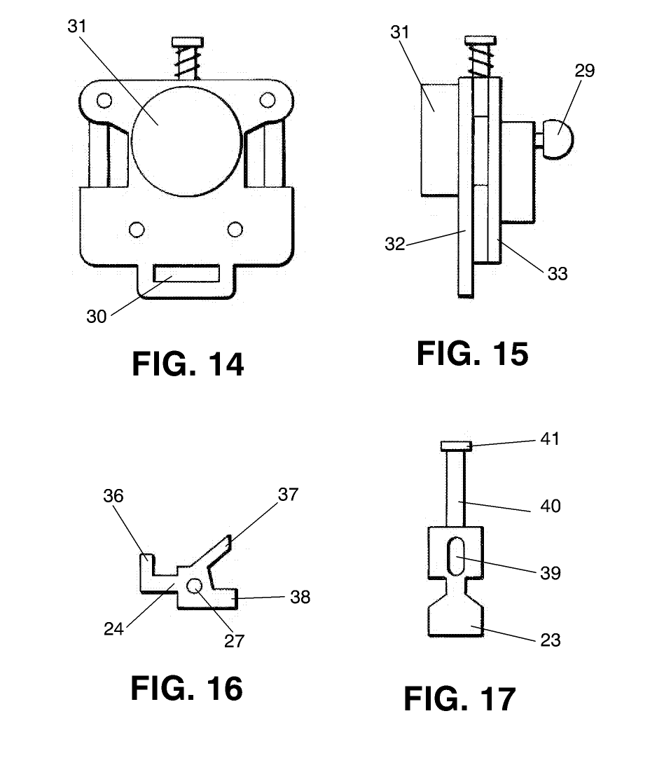

On the other hand, as depicted in FIGS. 6 and 12 to 18, the closure or clasp (9) consists of an electromechanical mechanism comprising an electromagnet (34) actuated by a sensor (16) sensing the position of the horse (2), where an actuation of said electromagnet (34) can open or close the quick closure (9).

The purpose of this electromechanical mechanism is to bring the two ends of the belt (4) going around the rider (1) together with the front brace (5) of the harness at one anchoring point, such that the rider (1) is secured or released only at that point. A simple, efficient and quick securing or release of the rider (1) is thereby achieved.

The mechanism can be opened manually by the action of the rider (1) or automatically by the action of an electromagnet (34) or an electric motor which is activated when it receives the command from a sensor (16) located on the horse (2). This command is produced when said sensor (16) detects a fall of the animal (2).

It has two plates (32, 33) consisting of a front base plate (33) and rear base plate (32) and a guide (25) providing support to the rest of the elements.

The guide (25) has an inverted U shape and has a hole in the upper part of said U. These are configured in this order: front base plate (33), guide (25), rear base plate (32). These three elements can be attached by means of screws, rivets or welding.

Both plates (32, 33) have four aligned holes through which four bolts (26, 27) are inserted. The two upper bolts (26) serve as a hinge for two clips (20) or pins the purpose of which is to secure the two ends of the safety belt (4) going around the rider (1). The two lower bolts (27) serve as a hinge for two clamps (24), and the purpose of the bolts is to secure or release the clips (20) described above during their rotational movement. To that end, each clamp (24), as seen in FIG. 16, comprises a pin anchor (36), a release arm (37) and a fixing arm (38).

The rotation of these clamps (24) is controlled by the upward and downward movement of a piston (23) in a linear movement which is limited in travel. This piston (23) fits between two projections of the clamps (24) as a result of which it rotates them. The movement thereof is guided by the front base plate (33) and rear base plate (32), and the guide (25) described above. The piston (23) is planar in the area where it runs between the plates (32, 33) and the guide (25). Furthermore, said piston (23) has a circular section in its upper part (40) as a result of which it traverses the hole of the guide (25), protrudes above it and provides housing to a spring (21), while at the same time serving as a stop for it at the top. When the piston (23) moves downwards and is locked in its position such that the quick closure (9) is securing the ends of the belt (4), the spring (21) is compressed between the guide (25) and the stop (41) at the top of the piston (23), attempting to push the piston (23) upwards, which movement would release the mechanism and undo the belt (4).

The piston (23) has a dual-purpose groove (39) in its central part. On one hand, it serves so that another element, the finger (35), is introduced in this groove (39) and provides it with the necessary anchoring. On the other hand, it serves so that the rod (22) or core of the electromagnet freely traverses said piston (23) and can act on the finger (35).

The finger (35) is the element designed to provide anchoring to the mechanism. It acts on the piston (23) securing it in a position in which it keeps the quick closure (9) closed, holding the ends of the belt (4) on the rider (1). It is anchored on the transverse bolt (28) such that its movement is rotational. It has a sphere or pulling member (29) for the finger protruding from the assembly of the quick closure (9) for the manual operation thereof by the rider (1) who, upon pulling on it outwardly, releases the piston (23) which, due to the effect of the spring (21), moves upwards, rotating the clamps (24) and releasing the clips (20).

The same effect is produced if the rod (22) of the electromagnet pushes the finger (35) due to the action of the electromagnet (34). Said rod (22) is operated by the electromagnet (34), pushing it against the finger (35), which moves it outwardly as if it were manually operated.

Said electromagnet (34) will have sufficient force to push the finger (35) and release the piston (23). The piston (23) does not collide with the rod (22) because the travel of the piston (23) is below the groove (39) where the rod (22) freely passes.

The electromagnet (34) is protected by a case (31) designed for such purpose.

The rear base plate (32) has a slot (30) in its lower part for being fixed to the front anchor (5) of the harness. Unlike the two ends of the belt (4), this anchor is not released and does not affect the operation of the quick closure (9).

The safety closure or lock can be instantly opened manually by means of the push button to allow the rider to be released from the harness in the event that the horse falls either because it slips on the ground or trips when jumping over a hurdle. The main belt of the harness has two stirrups or straps around the securing belt, two rear stirrups or straps each provided with a steel ring and another stirrup or strap for the closure.

According to a preferred embodiment, the device according to claim 9 wherein the sensor (16) is located in the securing base (8) and comprises a microprocessor which can receive signals from at least one position sensing element such that it records the following data:
acceleration in three axes of space consisting of a vertical axis passing through the withers of the horse (2), a horizontal axis running in the longitudinal direction of the horse (2) in the forward movement direction and a horizontal axis in the transverse direction of the horse (2), and
rotation about the two horizontal axes.

The sensor (16) consists of an electronics board located on the withers of the horse (2), conveniently isolated from blows and moisture as a result of a leak-tight case, and paced in a horizontal position. It comprises a microprocessor receiving the signals from several position sensing elements such that the following data are recorded:
acceleration in the three axes of space, which in this specific case are analogous to a vertical axis (Z axis) passing through the withers of the animal; a horizontal axis running in the longitudinal direction of the horse in the forward movement direction thereof (X axis); and a horizontal axis in the transverse direction of the horse (Y axis), and
rotation about the two horizontal axes (X and Y axes) described above.

A large rotation about the X axis means that the horse is falling to the side, and a large rotation about the Y axis means it is falling forward or backwards.

In this case, the position sensing elements are an accelerometer in the three X, Y, Z axes; and two gyroscopes in two axes, where each one collects the data about the rotation around the X axis and the Y axis. The doubling of the measurement of the rotation in each horizontal X and Y axis should be noted.

The microprocessor is connected and programmed with the suitable software developed for this application specifically such that it collects the signals from each movement sensing element; unifies them around the “time” axis as a result of the inner clock of the microprocessor; performs filtering eliminating signals that show disturbances; determines final components depending on the resultant of the composition of the data about movements in all the axes, which components are considered to represent the actual movement; processes these resulting components according to the law of physics linking acceleration, speed and space; and compares them with an established standard with regard to signals of natural horse movements and signals indicative of unstable movements predicting the fall of the animal, taking the suitable determination and in the event of foreseeing that the animal will fall, giving an electric signal which acts on an electromagnet or an electric motor located in the quick closure, or if required, on an intermediate relay between the sensor and the solenoid or the motor, whichever is appropriate, capable of opening said quick closure.

In view of this description and set of drawings, the person skilled in the art will understand that the embodiments of the invention which have been described can be combined in multiple ways within the object of the invention. The invention has been described according to some preferred embodiments thereof, but for the person skilled in the art it will be evident that multiple variations can be introduced in said preferred embodiments without exceeding the object of the claimed invention.

1. Safety device for saddles, comprising:
B) a quick closure including an electromechanical mechanism comprising an electromagnet, to which the ends of a belt and one end of at least one securing element can be anchored, and
C) a sensor sensing the position of the horse which can act on the electromagnet of the closure or clasp, where the actuation of said electromagnet can open or close the quick closure,
wherein the safety device comprises:
A) a harness comprising:
a securing base having a shape which adapts to the horse and is made of Kevlar, carbon fiber or other composites and combines stiff parts with flexible parts, wherein said securing base is located between the saddle and the horse, having two bars in its rear part, one on each side, attached in an articulated manner to the securing base by means of hinges firmly anchored to the securing base,
a belt which is attached to the bars by means of stirrups or straps, and the ends of which are coupled to a closure or clasp attached to the securing base by means of a strap or band.

2. Device according to claim 1, wherein the bars can rotate with respect to the rear hinges or anchors and have a curved shape that opens outwardly.

3. Device according to claim 1, wherein the bars can rotate freely backwards, but their forward travel is limited by means of an inner stop of the hinge.

4. Device according to claim 1, wherein the free ends of the bars are curved.

5. Device according to claim 1, wherein the sensor is located in the securing base and comprises a microprocessor which can receive signals from at least one position sensing element such that it records the following data:
acceleration in three axes of space consisting of a vertical axis passing through the withers of the horse, a horizontal axis running in the longitudinal direction of the horse in the forward movement direction and a horizontal axis in the transverse direction of the horse, and
rotation about the two horizontal axes.
